(19) United States
(12) Patent Application Publication
(10) Pub. No.: US 2007/0130419 A1
(43) Pub. Date: Jun. 7, 2007

(54) Device for and method of recording digital information signals

(75) Inventors: Johannis Friso Rendert Blacquiere, Eindhoven (NL); Gerrit Jan Scholl, Eindhoven (NL); Pope Ijtsma, Eindhoven (NL); Dirk Hamelinck, Beerzel (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/579,305

(22) PCT Filed: Nov. 15, 2004
(86) PCT No.: PCT/IB04/52423

§ 371 Date: May 16, 2006

(30) Foreign Application Priority Data
Nov. 21, 2003 (EP) 03104312.8

(51) Int. Cl. G06F 13/00

(52) U.S. Cl. 711/111

(57) ABSTRACT

A recording apparatus for recording digital information signals on a removable rewritable disc like recording medium has been proposed. The apparatus comprises writing means (21, 22, 25) for recording the digital information signals and control means (20) for controlling the recording. The apparatus is capable of storing first file system data and second file system data addressing user data in a user area (UA) on the medium. The control means (20) are adapted to define partitions for both file systems such that the partitions start at the same location and to store the second file system directory entries outside the first file system partition. This reduces time and space necessary for handling the second file system data by allowing two file systems to share their file entries, while protecting the second file system directory entries from being erased when the medium is under control of the first file system.

The invention relates to a device for recording digital information signals in addressable locations on a removable rewritable disc like recording medium, the medium comprising a user area for recording user data represented by the digital information signals, a spare area outside the user area comprising replacement areas for defect management, a table area outside the user area and outside the spare area for recording a defect table comprising a list of addresses of the replacement areas and defect areas in the user area, the device comprising

recording means for recording the digital information signals on the medium;

reading means for reading recorded digital information signals recorded on the medium;

control means for controlling recording the digital information signals, for defining on the medium a first file system partition inside the user area for recording first file system directory and file entries pointing to the user data, the first file system partition beginning at a first location, and for defining on the medium a second file system partition for recording second file system directory and file entries pointing to the user data, the second file system partition substantially overlapping with the user area and beginning at a second location.

The invention further relates to a method of recording digital information signals in addressable locations on a removable rewritable disc like recording medium, the medium comprising a user area for recording user data represented by the digital information signals, a spare area outside the user area comprising replacement areas for defect management, a table area outside the user area and the spare area for recording a defect table comprising addresses of the replacement areas and defect areas in the user area, the method comprising

defining on the medium a first file system partition inside the user area for recording first file system directory and file entries pointing to the user data, the first file system partition beginning at a first location;

defining on the medium a second file system partition for recording second file system directory and file entries pointing to the user data, the second file system partition substantially overlapping with the user area and beginning at a second location.

The invention also relates to a computer data system comprising a computer connected to a device for recording digital information signals in addressable locations on a removable rewritable disc like recording medium, the digital information signals representing user data, first file system data and second file system data, each file system data comprising a corresponding set of file entries, the file entries comprising address references pointing to the user data according to a predefined format and defined relative to a reference point, the device comprising

input means connected to the computer for receiving the digital information signals;

recording means for recording the digital information signals on the medium;

reading means for reading recorded digital information signals recorded on the medium;

output means for outputting the read digital information signals to the computer;

control means for controlling recording the digital information signals.

The invention further relates to a computer program product for recording digital information signals in addressable locations on a removable rewritable disc like recording medium.

Recording media like optical discs (DVD+RW, Blu-ray Disc, etc.) are capable of storing large amount of data of different types. They can be used in different environments having specific requirements as for organization of data on a recording medium. Typically, data are organized into files in accordance with rules of a particular file system. Such file system has its own file system data, which include information about all kind of structures relating to data stored on a recording medium. In particular, file system data may include volume structures representing the structures of logical and/or physical volumes, file entries representing the structures of files containing the data, directory entries describing grouping of files, and a space bitmap representing allocated and/or unallocated space for storing data on a recording medium. A recording medium may comprise addressable recording units for storing the data. At a level of a file system those units are referenced to with use of logical addresses defining a contiguous addressing (storage) space to be used for storing sequences of information blocks, such as files under control (according to rules) of the file system, for example UDF. Partitioning of the recording medium allocates this space on the medium.

At present, for example, DVD+RW discs are in use by Consumer Electronics (CE) devices and in the Personal Computer (PC) environment. In the CE environment DVD+RW discs are used mainly for recording digital video information according to a format of DVD Video Recording, commonly referred to as DVD+VR. This means that there are defined specific allocation rules and set of files containing the video information itself and information about that video information such as title information, menu structures, etc. Next to that the (predefined) list of files has to be physically on a medium in a certain order.

The PC environment is based on a different philosophy. There are, in principle, no specific allocation requirements. Specific applications may require some files to be present in a certain directory and applications will typically have their own data format to store information in files or to retrieve information from a file. This means that as long as there is free space available on a medium it is possible to add data files to that medium from all kinds of different applications. As an example, on a single disc there could be multi-media files, text files and executable files all mixed with each other.

Recently, more and more CE devices, like video players/recorders, have capability to seek through the file system information on the disc for files of a certain type that they can handle as well. Example of this are (mainly) JPEG files and also, already more and more, MP3 files. In the future possibly more types of multi-media files will be supported in the CE world. Next to that, also new standards on meta-data are created (such as e.g. MPV or HighMAT) designed to make it easier to move digital content between PCs and home electronics devices, e.g. by providing a common “look and feel” in different environments.

The published international patent application WO 01/22416 A1 discloses the device capable of performing initialization, formatting and defect management of a rewritable medium such as a CD-RW disc. This is done to facilitate the use of CD-RW as a high-capacity floppy disc, so immediate recording or reading of files is possible. Such media are commonly referred to as Mount Rainier ReWritable (MRW) media, e.g. CD-MRW, DVD+MRW.

The device has recording means for recording the information in information blocks having logical addresses on an optical disc in a track at allocated physical addresses. The logical addresses constitute a contiguous storage space. In practice, the record carrier may exhibit defective parts of the track, in particular a defect preventing a block to be recorded at a specific physical address. These defects might be caused by scratches, dust, fingerprints and so on. Initially, before any user data is recorded, defects are detected, and physical addresses of defective sectors are removed from use in a defect table, a process usually called slipping. In the event of defects detected during use of the record carrier, logical addresses assigned to defective physical addresses are assigned to different physical addresses in a defect management area called also a spare area, a process usually called remapping or linear replacement.

Further, said device makes it possible to store file system data of different file systems on one recording medium, so-called “bridge medium”. This facilitates sharing of the bridge medium between different environments, e.g. the CE environment and the PC environment. A special part of a recording medium, called a general application area (GAA), is allocated for storing e.g. file system data of a file system used by other devices. In case of DVD+MRW media, GAA has a size of 2 MBytes.

In the PC environment the most likely way of adding data to the bridge medium is by means of “drag-and-drop” technique. A user can then make the medium compatible with legacy players through the use of a compliance (bridge) application running on the PC. Basically, the application writes second file system data, called “CE-bridge”, to the medium, using the suitable file system(s) and content pointers, such that a legacy “non-MRW” system can interpret these as content under its main file system. As a result, the CE-player will play the content that is referenced by this file system data, for which it has suitable content decoders.

Creation or modification of the CE-bridge requires searching through the first file system data and copying file/directory entries to the CE-bridge. Moreover, it requires modifying all file/directory entries that are copied to the CE-bridge. This is so because address references stored inside file/directory entries are defined relative to the start of a partition of a file system. Searching for, copying and modifying file/directory entries is a time and space consuming process.

Therefore, it is an object of the invention to provide more economic way of sharing the bridge medium between different environments.

This object is achieved, according to a first aspect of the invention, by a device for recording digital information signals of the type described in the opening paragraph, characterized in that the control means are adapted to define both partitions such that the first location is the same as the second location, to define the second file system partition having an outside part outside the first file system partition and to record the second file system directory entries in the outside part This reduces time and space necessary for handling the CE-bridge by allowing two file systems to share their file entries, while protecting the second file system directory entries from being erased when the medium is under control of the first file system.

In an embodiment of the device for recording digital information signals, the control means are adapted to define the outside part inside the user area. This embodiment is advantageous in that both file system partitions fit within the user area thus not affecting other areas on the medium.

In a further embodiment of the device for recording digital information signals, the control means are adapted to define the outside part outside the user area This allows for the first file system partition to have a maximum size within the user area.

In another embodiment of the device for recording digital information signals, the control means are adapted to define the outside part inside the spare area and to mark an overlap part of the spare area overlapping with the outside part as unusable in the defect table. This protects the second file system data in the outside part from overwriting by the defect management

In another embodiment of the device for recording digital information signals, the control means are adapted to search the defect table for a replacement area address of a replacement area in the overlap part comprising recorded user data, to localize the replacement area according to the replacement area address, to search the defect table for a free replacement area address of a free replacement area outside the overlap part without the user data, to localize the free replacement area according to the free replacement area address, to read the recorded user data from the replacement area, to record the user data read from the replacement area in the free replacement area and to mark the replacement area as unusable in the defect table. This is advantageous in that it protects the user data in the overlap part of the spare area allocated to the second file partition from overwriting under control of the second file system.

It is advantageous, if the control means are adapted to define the second file partition comprising the spare area This allows the user data remapped to the spare area to be addressed from within the second file system partition.

A further embodiment of the device for recording digital information signals is characterized in that the control means are adapted to mark an additional spare area as unusable in the defect table for the medium comprising the additional spare area outside the spare area and the user area comprising additional replacement areas, the defect table comprising addresses of the additional replacement areas. This ensures that no user data can be added in the additional spare area, which is not accessible from the second file system partition.

In another embodiment of the device for recording digital information signals, the control means are adapted to search the defect table for an additional replacement area address of an additional replacement area comprising recorded user data, to localize the additional replacement area according to the additional replacement area address, to search the defect table for a free replacement area address of a free replacement area out of the replacement areas without the user data, to localize the free replacement area according to the free replacement area address, to read the recorded user data from the additional replacement area, to record the user data read from the additional replacement area in the free replacement area and to mark the additional replacement area as unusable in the defect table. This provides a way of remapping the user data from the additional spare area

According to a second aspect of the invention a method of recording digital information signals of the type described in the opening paragraph is provided, characterized by:

defining both partitions such that the first location is the same as the second location;

defining the second file system partition having an outside part outside the first file system partition;

recording the second file system directory entries in the outside part.

According to a third aspect of the invention a computer data system of the type described in the opening paragraph is provided, characterized in that the computer is adapted to control the control means of the device for recording digital information signals to perform the method as described in relation to the second aspect of the invention.

According to a fourth aspect of the invention a computer program product for recording digital information signals recorded on a removable rewritable disc like recording medium is provided, which program is operative to cause a processor to perform the method as described in relation to the second aspect of the invention.

These and other aspects of the invention will be apparent from and elucidated further with reference to the embodiments described by way of example in the following description and with reference to the accompanying drawings, in which:

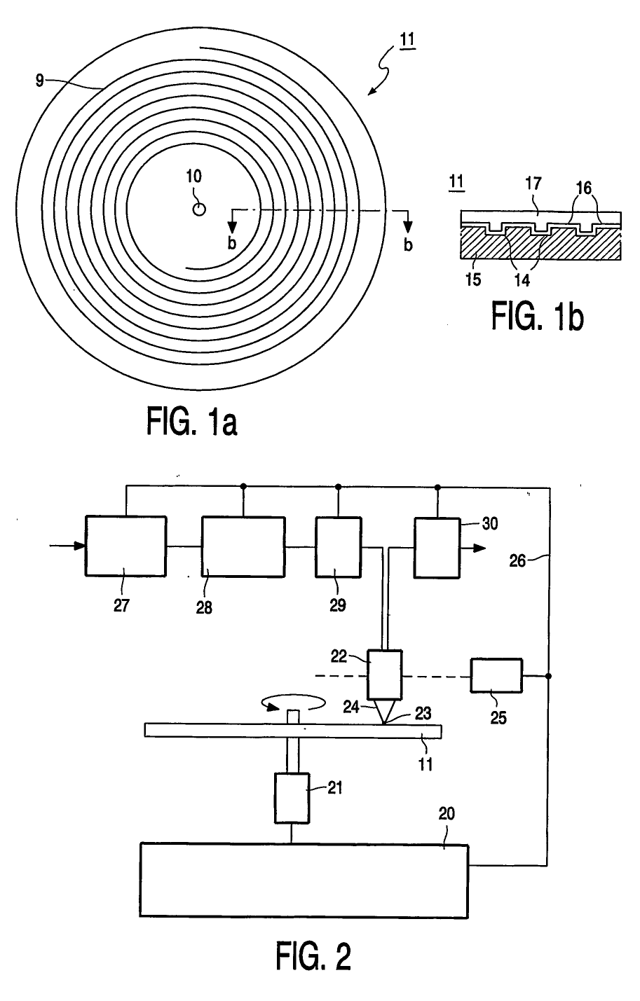

FIG. 1a shows a recording medium (top view),

FIG. 1b shows a recording medium (cross section),

FIG. 2 shows a device for recording digital information signals, in accordance with the invention,

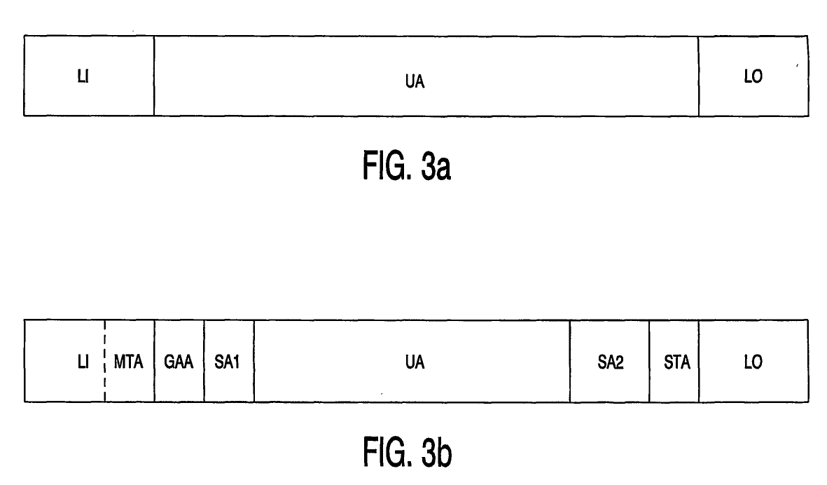

FIG. 3a shows a simplified layout of a non-MRW type of medium,

FIG. 3b shows a simplified layout of a MRW type of medium,

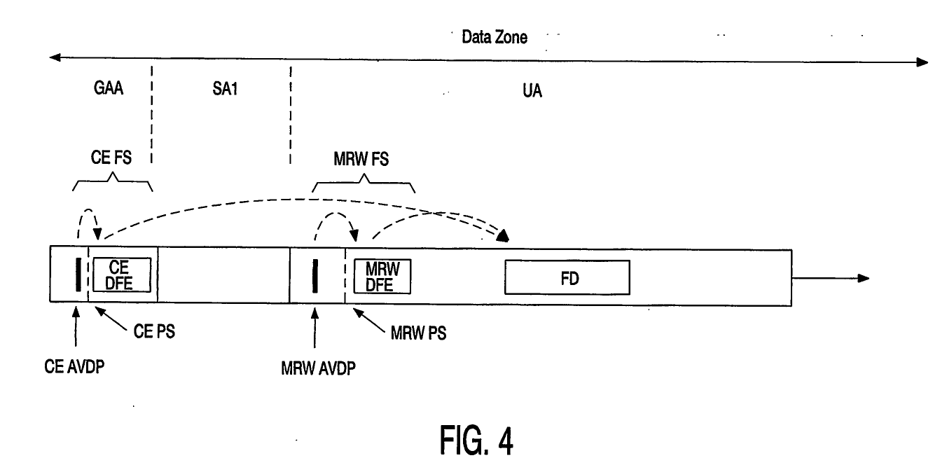

FIG. 4 shows an example of a simplified structure of the DVD+MRW bridge medium with the MRW partition and the CE partition starting at different locations.

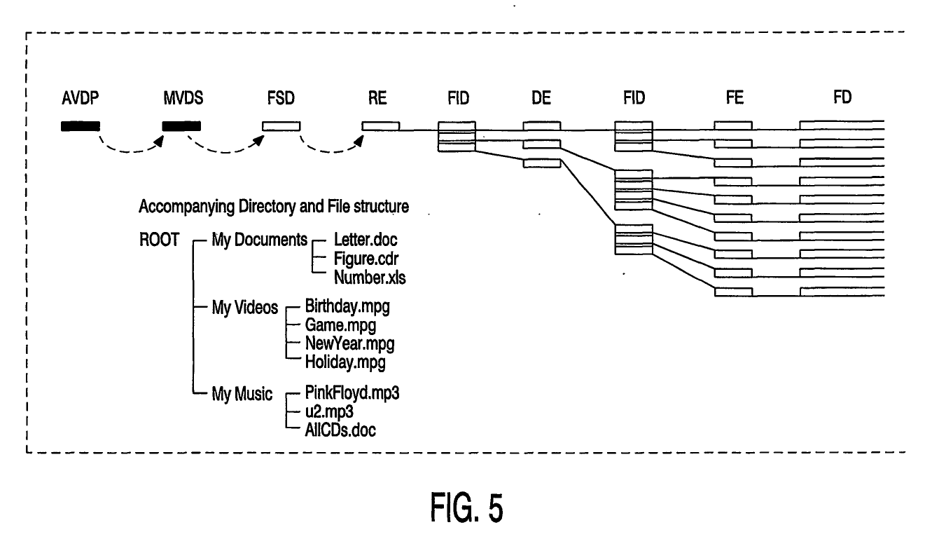

FIG. 5 shows a simplified structure of a UDF file system,

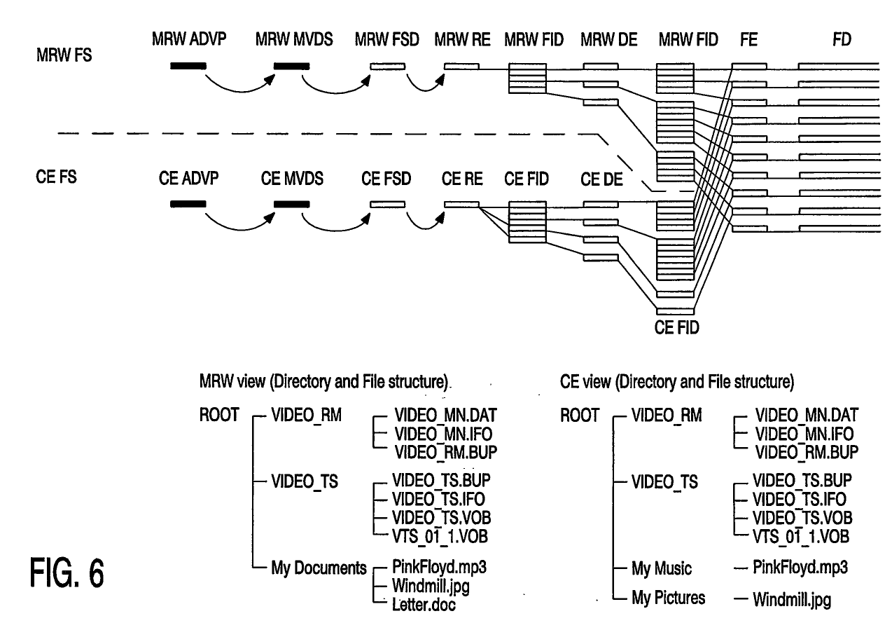

FIG. 6 shows schematically MRW and CE file system structures sharing File Entries, in accordance with the invention.

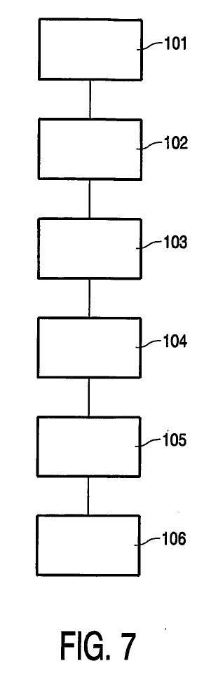

FIG. 7 shows an example of a method of recording digital information signals, in accordance with the invention.

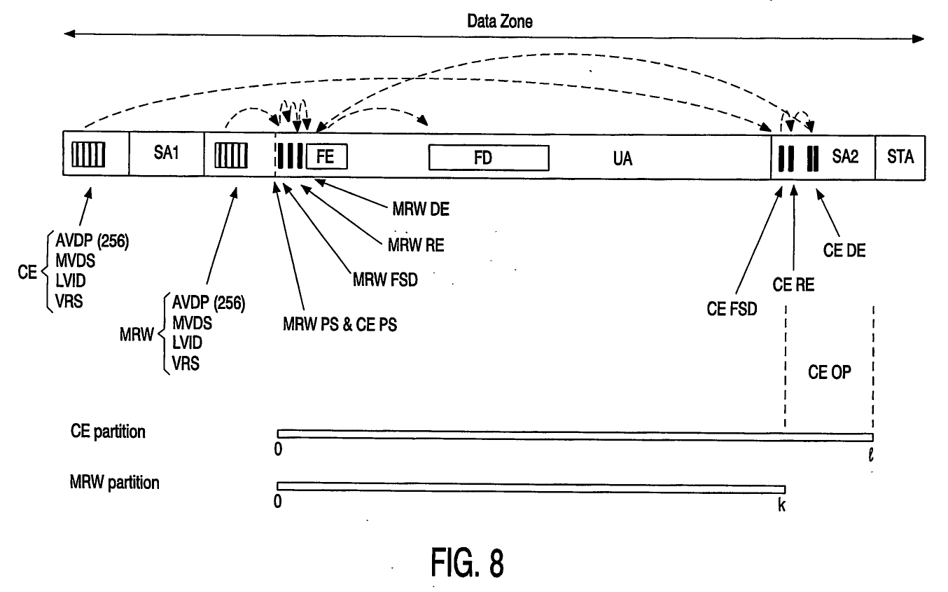

FIG. 8 shows an example of a simplified structure of the DVD+MRW bridge medium with the MRW partition and the CE partition starting at the same location and with the CE Directory Entries recorded in the spare area of the defect management, in accordance with the invention.

Corresponding elements in different Figures have identical reference numerals and symbols.

FIG. 1a shows an example of a recording medium 11 having a form of disc with a track 9 and a central hole 10. The track 9, being the position of the series of (to be) recorded marks representing digital information signals (data), is arranged in accordance with a spiral pattern of turns constituting substantially parallel tracks on an information layer. The recording medium may be optically readable, called an optical disc, and has an information layer of a recordable type. Examples of a recordable disc are the CD-RW, and writable versions of DVD, such as DVD+RW, and the high-density writable optical disc using blue lasers, called Blu-ray Disc (BD). Digital information signals (data) are represented on the information layer by recording optically detectable marks along the track, e.g. crystalline or amorphous marks in phase change material. The track 9 on the recordable type of recording medium is indicated by a pre-embossed track structure provided during manufacture of the blank recording medium. The track structure is constituted, for example, by a pregroove 14, which enables a read/write head to follow the track during scanning. The track structure comprises position information, e.g. addresses, for indication the location of units of information, usually called information blocks or packets.

FIG. 1b is a cross-section taken along the line b-b of the recording medium 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

FIG. 2 shows a device for recording digital information signals a recording medium 11 such as CD-RW, DVD+RW or BD, in accordance with the invention. The device is provided with recording means for scanning the track on the recording medium, which means include a drive unit 21 for rotating the recording medium 11, a head 22, and a positioning unit 25 for coarsely positioning the head 22 in the radial direction on the track. The head 22 comprises an optical system of a known type for generating a radiation beam 24 guided through optical elements focused to a radiation spot 23 on a track of the information. layer of the recording medium. The radiation beam 24 is generated by a radiation source; e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For recording digital information signals (data) the radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. For reading, the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve the digital information signals (data). Hence retrieving means for reading information include the drive unit 21, the head 22, the positioning unit 25 and the read processing unit 30. The device comprises write processing means for processing input data to generate a write signal to drive the head 22, which means comprise an input unit 27, and modulator means comprising a formatter 28 and a modulator 29. The input data may comprise for example real-time video and/or audio data, still images data or other user data. The input unit 27 processes the input data to units of information, which are passed to the formatter 28 for adding control data and formatting the data, e.g. by adding error correction codes (ECC) and/or interleaving. The formatted data from the output of the formatter 28 is passed to the modulation unit 29, which comprises for example a channel coder, for generating a modulated signal, which drives the head 22. Further the modulation unit 29 comprises synchronizing means for including synchronizing patterns in the modulated signal. The formatted units presented to the input of the modulation unit 29 comprise address information and are written to corresponding addressable locations on the recording medium under the control of a control unit 20. The control unit 20 controls the recording and retrieving of information and may be arranged for receiving commands from a user or from a host computer. The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits.

In an embodiment the device is a storage system only, e.g. an optical disc drive for use in a computer. The control unit 20 is arranged to communicate with a processing unit in the host computer via a standardized interface (not shown). Digital data is interfaced to the formatter 28 and from the read processing unit 30 directly. In this case, the interface acts as the input unit and an output unit; as an option, the input unit 27 does not have to be present in the device.

In an embodiment the device is arranged as a stand alone unit, for example a video recording apparatus for consumer use. The control unit 20, or an additional host control unit included in the device, is arranged to be controlled directly by the user, and to perform the functions of the file system(s). The device includes application data processing, e.g. audio and/or video processing circuits. User information is presented on the input unit 27, which may comprise compression means for input signals such as analog audio and/or video, or digital uncompressed audio/video. The read processing unit 30 may comprise suitable audio and/or video decoding units.

The control unit 20 is capable of performing initialization, formatting and defect management of a rewritable medium such as a DVD+RW disc. An example of simplified layout of such disc is shown in FIGS. 3b and 4. It comprises lead-in area LI, lead-out area LO, a general application area GAA, a spare area SA (in this example comprising two sub-areas SA1 and SA2), a user area UA, and table areas MTA and STA. LI and LO contain mainly media read/write definition and administration data. The user area UA is used mainly for recording of data used for real use and data related to content stored on a recording medium, such as user data organized in file data FD and first (main) file system data, MRW FS, comprising directory and file entries, MRW DFE, pointing to the user data according to rules of a first file system. The general application area GAA can be used for storage of data that does not allow replacements by the defect management, such as application programs or device drivers that can handle defects, or file system data of additional file systems. The defect management is based on a main defect table MDT stored in a main table area MTA, a secondary defect table SDT stored in a secondary table area STA and replacement areas (packets) comprised in the spare area SAI, SA2. The secondary defect table is a copy of the main defect table; SDT contains the same information as MDT. STA is used as redundancy in case of issues with MTA, and for assuring that non-MRW PC-systems can use these tables for address remapper in order to logically construct the address space, compensating for the defect management reallocation (not interpretable by non-MRW drives). The main table area MTA is located within the lead-in area LI. Recording media with a layout of the type shown in FIGS. 3b and 4 are commonly referred to as Mount Rainier ReWritable (MRW) media, e.g. CD-MRW or DVD+MRW, in contrast to “non-MRW” media with a layout as in example shown in FIG. 3a. In case of DVD+MRW recording media, GAA, SA1 and SA2 have a size of 2, 8 and 120 (or 504) MBytes, respectively. MRW PS and CE PS indicate a start (beginning) of the MRW file system partition and the CE file system partition, respectively.

The control unit 20 is capable of controlling recording of file system data of different file systems on one recording medium, so-called “bridge medium”. This facilitates sharing of the bridge medium between different environments, e.g. the CE environment and the PC environment as explained in the introductory part.

Based on the MRW definitions, it is possible to ensure that MRW media can be read by non-MRW capable drives, by installing a remapping driver on the PC. This remapping driver can be obtained easily, amongst other, by using GAA, such that the file system in GAA launches an application, which installs this driver or downloads it from the Internet. For convergence with non-MRW aware CE devices, a file system of the same or a different type (typically IS09660 or UDF) can be used for allowing addressing of the content typically recognized by CE devices. This is done by pointing to the multimedia content stored in UA of the MRW medium, using file system data stored in GAA, hereinafter also referred to as second file system data, CE FS, with its own directory and file entries, CE DFE. At least the base structures of the second file system (like anchor) always need to be in the standard GAA in order to allow the second file system to be mounted in CE-devices or any device without MRW knowledge.

The defect table MDT contains information, which can be used to perform the defect management. In particular, the defect table contains a list of defective areas (packets), which have been determined to be defective during verification or during use of the medium, according to rules of the defect management Further, it contains a list of replacement areas (packets), reserved to be used as replacements of defective areas. Defective and replacement areas are referred to by their addresses on the medium. Different flags or status bits within the defect table indicate characteristics of those areas, e.g. usability for data recording. The defect table also contains information related to areas on the medium, where the defect. management shall not be active, such as a size and position of GAA.

In an embodiment, the control unit 20 functions as so-called “bridge application”. File and directory entries of one file system are mirrored in equivalents of other data structure belonging to other file system. During this process, information about changes in file systems data is gathered and then all or only selected file/directory entries are mirrored. This selection is done using a pre-defined set of file types, file systems characteristics or other conditions. After addition (modification) of the data on the bridge medium, file systems data must be synchronized by the bridge application. Depending whether the medium is used in a “knowledgeable” environment, i.e. the environment wherein it can be assured that two file systems data are kept synchronized, or in an “unknowledgeable” environment (where the two file systems data can not be kept synchronized), the medium may have correct or incorrect CE bridge information, respectively. Therefore special actions of a special convergence bridge application able to restore the CE bridge, have to be performed. This could be a part of the functionality of the “knowledgeable” environment, to assure the medium always leaves this environment with the correct CE bridge.

FIG. 5 shows a simplified structure of a UDF file system representing the directory and file structure on a recording medium. The Anchor Volume Descriptor Pointer AVDP points toward the Main Volume Descriptor Sequence MVDS, which comprises the Logical Volume Descriptor LVD, the Partition Descriptor PD, the Primary Volume Descriptor PVD, the Implementation Use Volume Descriptor IUVD and the Unallocated Space Descriptor USD. LVD contains information about the logical volume. It points toward the File Set Descriptor FSD. Partitions map logical space to physical space. Normally, this is a linear mapping where an offset (location) and a length (size) is specified by PD. PVD contains some information about the physical volume, whereas IUVD contains implementation specific information about the volume. Information about free space on the volume is comprised in USD. AVDP is located at the logical block having the logical address 256. For example, for MRW FS on a DVD+MRW medium, this logical address corresponds to the 5376^{th} physical block after the lead-in (in case there is no remapping applied). The UDF file system structure comprises also the Volume Recognition Sequence VRS at the logical address 16. AVDP, MVDS and VRS are located outside the partition. FSD identifies, a set of files and directories and contains a pointer to so-called ROOT Entry RE that describes the ROOT directory. The directory and file tree that gives a user an overview of the contents on the medium, starts at the ROOT directory and is created via Directory and File Entries, DE and FE respectively, that are all linked to each other via pointers as shown schematically by arrows in FIG. 5. Also shown in FIG. 5 are the File Identifier Descriptors (FID); they can be seen as the data of a directory and they contain pointers to files and directories in that particular directory. RE, FID, DE and FE together form the file and directory structure of the UDF file system. They are located inside the partition. Each file entry contains address references (links) pointing to data belonging to a corresponding file. The address references have a format specific for a given file system and are defined relative to a reference point, which in case of UDF is a beginning of the partition. The ROOT Entry, Directory Entries and File Entries of the UDF file system have the same data format defined by the UDF specification and use the same reference point; they are often called simply file entries. Generally, MRW and CE address references can be defined relative to different reference points, for example when MRW and CE partitions start at different points as shown in FIG. 4.

The control unit 20 is adapted to define both partitions such that the first location is the same as the second location, to define the second file system partition having an outside part outside the first file system partition and to record the second file system directory entries in the outside part. The AVDP, MVDS, VRS and FSD of both file systems data (in this case UDF file systems data) are recorded on the medium. This can be performed as one action (recording the MRW and CE file systems data) or two actions separated in time, where first, the MRW file system data are recorded and later, the CE file system data are recorded, e.g. as a result of a “make convergence” request. The control unit 20 sets the same starting point (location) for partitions defined by partition descriptors MRW PD and CE PD. Thus, the bridge medium is obtained on which it is enough to record only one, common set of file entries shared by both file systems data, as shown in FIG. 6. The file entries FE forming one, common set are pointed to by directory entries corresponding to different file systems data, MRW DE and CE DE. FIG. 8 shows an example of a simplified structure of the DVD+MRW bridge medium with shared file entries FE. The CE partition has a size “1”, which is larger than a size of the MRW partition “k”. This means that the CE partition has a part, hereinafter called the CE outside part, CE OP, which is outside the MRW partition (between “k” and “l” in FIG. 8). The control unit 20 uses that part to record the CE FS directory entries CE DE. Also, File Set Descriptor, ROOT Entry and File Identifier Descriptors of the CE FS are recorded in the CE outside part. A safe area is created in the CE partition that is not a part of the MRW partition. This means that CE FSD and other CE FS view entries written in that space are not inside the MRW partition and as a result safe from overwriting or deleting files in the MRW partition and vice-versa. In an embodiment of the device, the control unit 20 defines the CE outside part inside the user area UA.

A particular method performed by the control unit 20 of an embodiment of the device is shown in FIG. 7. In a step INITI 101, the first file system partition is defined and basic MRW FS structures such as AVDP, MVDS, VRS and FSD are recorded on the medium. Next, in a step INIT2 102, the second file system partition is defined and basic CE FS structures such as AVDP, MVDS, VRS and FSD are recorded on the medium. Both partitions have the same starting point and different sizes; the size of the second file system partition is larger than the size of the first file system partition. The MRW FS file and directory entries (together with corresponding MRW FID) are generated in step GENERATEl 103 and then recorded on the medium in a step RECORDI 104. Next, the CE FS directory entries are generated (together with corresponding CE FID) in a step GENERATE2 105 and then recorded in the CE outside part on the medium in a step RECORD2 106. It is not necessary to generate and to record the CE FS file entries as both file systems share their file entries. The step INIT2 102 can also be executed after the step RECORD1 104. Alternatively, steps 103 and 105, and/or steps 104 and 106, can be combined together.

In another embodiment of the device, the control unit 20 is capable of defining the CE outside part outside UA. In a particular case, the CE outside part is within the spare area SA2 as shown in FIG. 8. Storing CE FSD, CE RE, CE FID and CE FD in SA2 requires some precautions to avoid that the MRW defect management deletes this information by using the SA2 locations in which this information is stored. The control unit 20 marks a part of the spare area SA2, hereinafter also called the overlap part, overlapping with the CE outside area, as unusable in MDT, in order to avoid conflicts with the defect management. All replacement areas comprised in the overlap part are marked as unusable in MDT.

In an embodiment of the device, the control unit 20 is capable of freeing-up space in the overlapping part of SA2 by moving its content (user data or MRW FS data) to free areas, based on information from MDT. This can be a part of the step 102 or the step 106 of the above described method. The control unit 20 is adapted to search MDT for a replacement area address of a replacement area in the overlap part comprising recorded data, to localize the replacement area according to the replacement area address, to search MDT for a free replacement area address of a free replacement area outside the overlap part without data, to localize the free replacement area according to the free replacement area address, to read the recorded data from the replacement area, to record the data read from the replacement area in the free replacement area, to indicate in MDT that the free replacement area comprises the user data and to mark the replacement area as unusable in MDT. This can be done by e.g. background action of the device, or can be the result of a special format command, which defines the second file system partition. The freed-up SA2 locations are marked as unusable in the defect table. As a result, these locations will not be overwritten in MRW systems. These locations are added to the CE partition—the CE outside part.

Advantageously, in another embodiment, the control unit 20 is adapted to define the CE partition, which covers the entire SA2 as shown in FIG. 8. This ensures that if there is any data from the MRW partition that is remapped (by the defect management) to SA2, it can be addressed from within the CE partition.

The DVD+MRW comprises an additional spare area SA1 as shown in FIGS. 3b and 4. Some data from the MRW partition can be remapped to SA1. The CE partition could be increased so it also covers the entire SAl. However, this would violate a requirement that the CE partition starts at the same physical location as the MRW partition to allow all MRW File Entries to be shared between the MRW FS and CE FS. Therefore, in another embodiment of the device, the control unit 20 is capable of marking the additional spare area SA1 as unusable in MDT, so SA1 is not used by the defect management.

In an embodiment of the device, the control unit 20 is capable of freeing-up space in the SA1 by moving its content (user data or MRW FS data) to free areas, based on information from MDT. This is done in a similar way as described above in case of SA2 by searching the defect table for an additional replacement area address of an additional replacement area comprising recorded data, to localize the additional replacement area according to the additional replacement area address, to search the defect table for a free replacement area address of a free replacement area out of the replacement areas without data, to localize the free replacement area according to the free replacement area address, to read the recorded data from the additional replacement area, to record the data read from the additional replacement area in the free replacement area, to indicate in the defect table that the free replacement area comprises the user data and to mark the additional replacement area as unusable in the defect table.

The user area UA and the spare area SA2 can be fragmented and interleaved with each other creating a “zebra-like” structure on the medium. In this case, the control unit 20 is adapted to define the CE partition, which extends over required number of fragments of the spare area. In another embodiment, the control unit 20 is capable of marking part(s) of one or more fragments of the spare area as unusable in MDT and allocating (defining) those parts for (as) the CE outside part. If necessary, space in the fragments of the spare area can be freed-up by using the technique described above.

In an embodiment of a computer data system comprising the host system and the device for recording digital information signals, the processing unit in the host system is adapted to control the control unit 20 to perform methods and functions as described in reference to embodiments of the device presented above.

A computer program product according to the invention is operative to cause the control unit 20 or the processing unit in the host system to perform methods and functions as described in reference to embodiments of the device presented above.

Whilst the invention has been described with reference to preferred embodiments thereof, it is to be understood that these are not limitative examples. Thus, various modifications may become apparent to those skilled in the art, without departing from the scope of the invention, as defined by the claims. Further, the invention lies in each and every novel feature or combination of features described above. Also, for the recording medium an optical disc has been described, but other media, such as a magneto-optical disc can be used. It is noted, that the invention may be implemented by means of a general purpose processor executing a computer program or by dedicated hardware or by a combination of both, and that in this document the word “comprising” does not exclude the presence of other elements or steps than those listed and the word “a” or “an” preceding an element does not exclude the presence of a plurality of such elements, that any reference signs do not limit the scope of the claims, that “means” may be represented by a single item or a plurality and that several “means” may be represented by the same item of hardware.

1. A device for recording digital information signals in addressable locations on a removable rewritable disc like recording medium, the medium comprising a user area for recording user data represented by the digital information signals, a spare area outside the user area comprising replacement areas for defect management, a table area outside the user area and outside the spare area for recording a defect table comprising a list of addresses of the replacement areas and defect areas in the user area, the device comprising
recording means for recording the digital information signals on the medium;
reading means for reading recorded digital information signals recorded on the medium; and
control means for controlling recording the digital information signals, for defining on the medium a first file system partition inside the user area for recording first file system directory and file entries pointing to the user data, the first file system partition beginning at a first location, and for defining on the medium a second file system partition for recording second file system directory and file entries pointing to the user data, the second file system partition substantially overlapping with the user area and beginning at a second location, characterized in that
the control means are adapted to define both partitions such that the first location is the same as the second location, to define the second file system partition having an outside part outside the first file system partition and to record the second file system directory entries in the outside part.

2. A device as claimed in claim 1, characterized in that the control means are adapted to define the outside part inside the user area.

3. A device as claimed in claim 1, characterized in that the control means are adapted to define the outside part outside the user area.

4. A device as claimed in claim 3, characterized in that the control means are adapted to define the outside part inside the spare area and to mark an overlap part of the spare area overlapping with the outside part as unusable in the defect table.

5. A device as claimed in claim 4, characterized in that the control means are adapted to search the defect table for a replacement area address of a replacement area in the overlap part comprising recorded user data, to localize the replacement area according to the replacement area address, to search the defect table for a free replacement area address of a free replacement area outside the overlap part without the user data, to localize the free replacement area according to the free replacement area address, to read the recorded user data from the replacement area, to record the user data read from the replacement area in the free replacement area and to mark the replacement area as unusable in the defect table.

6. A device as claimed in claim 1, characterized in that the control means are adapted to define the second file partition comprising the spare area.

7. A device as claimed in claim 1, the medium comprising an additional spare area outside the spare area and the user area comprising additional replacement areas, the defect table comprising addresses of the additional replacement areas, characterized in that the control means are adapted to mark the additional spare area as unusable in the defect table.

8. A device as claimed in claim 7, characterized in that the control means are adapted to search the defect table for an additional replacement area address of an additional replacement area comprising recorded user data, to localize the additional replacement area according to the additional replacement area address, to search the defect table for a free replacement area address of a free replacement area out of the replacement areas without the user data, to localize the free replacement area according to the free replacement area address, to read the recorded user data from the additional replacement area, to record the user data read from the additional replacement area in the free replacement area and to mark the additional replacement area as unusable in the defect table.

9. A method of recording digital information signals in addressable locations on a removable rewritable disc like recording medium, the medium comprising a user area for recording user data represented by the digital information signals, a spare area outside the user area comprising replacement areas for defect management, a table area outside the user area and the spare area for recording a defect table comprising addresses of the replacement areas and defect areas in the user area, the method comprising
defining on the medium a first file system partition inside the user area for recording first file system directory and file entries pointing to the user data, the first file system partition beginning at a first location; and
defining on the medium a second file system partition for recording second file system directory and file entries pointing to the user data, the second file system partition substantially overlapping with the user area and beginning at a second location,
the method characterized by
defining both partitions such that the first location is the same as the second location;
defining the second file system partition having an outside part outside the first file system partition; and
recording the second file system directory entries in the outside part.

10. A method as claimed in claim 9, characterized by defining the outside part inside the user area.

11. A method as claimed in claim 9, characterized by defining the outside part outside the user area.

12. A method as claimed in claim 11, characterized by
defining the outside part inside the spare area; and
marking an overlap part of the spare area overlapping with the outside part as unusable in the defect table.

13. A method as claimed in claim 12, characterized by
searching the defect table for a replacement area address of a replacement area in the overlap part comprising recorded user data;
localizing the replacement area according to the replacement area address;
searching the defect table for a free replacement area address of a free replacement area outside the overlap part without the user data;
localizing the free replacement area according to the free replacement area address;
reading the recorded user data from the replacement area;
recording the user data read from the replacement area in the free replacement area;
indicating in the defect table that the free replacement area comprises the user data; and
marking the replacement area as unusable in the defect table.

14. A method as claimed in claim 9, characterized in that the second file system partition comprises the spare area.

15. A method as claimed in claim 9, the medium comprising an additional spare area outside the spare area and the user area comprising additional replacement areas, the defect table comprising addresses of the additional replacement areas, characterized by defining the additional spare area as unusable in the defect table.

16. A method as claimed in claim 15, characterized by
searching the defect table for an additional replacement area address of an additional replacement area comprising recorded user data;
localizing the additional replacement area according to the additional replacement area address;
searching the defect table for a free replacement area address of a free replacement area out of the replacement areas without the user data;
localizing the free replacement area according to the free replacement area address;
reading the recorded user data from the additional replacement area;
recording the user data read from the additional replacement area in the free replacement area;
indicating in the defect table that the free replacement area comprises the user data; and
marking the additional replacement area as unusable in the defect table.

17. A computer data system comprising a computer connected to a device for recording digital information signals in addressable locations on a removable rewritable disc like recording medium, the digital information signals representing user data, first file system data and second file system data, each file system data comprising a corresponding set of file entries, the file entries comprising address references pointing to the user data according to a predefined format and defined relative to a reference point, the device comprising
input means connected to the computer for receiving the digital information signals;
recording means for recording the digital information signals on the medium;
reading means for reading recorded digital information signals recorded on the medium;
output means for outputting the read digital information signals to the computer; and
control means for controlling recording the digital information signals, characterized in that
the computer is adapted to control the control means of the device to perform the method according to claim 9.

18. A computer program product for recording digital information signals in addressable locations on a removable rewritable disc like recording medium, which program is operative to cause a processor to perform the method according to claim 9.
